(19) United States
(12) Patent Application Publication
(10) Pub. No.: US 2020/0091490 A1
(43) Pub. Date: Mar. 19, 2020

(54) INTERFACE BETWEEN JELLY ROLL AREA OF A BATTERY CELL AND CELL CAN

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/570,547

(22) Filed: Sep. 13, 2019

Related U.S. Application Data
(60) Provisional application No. 62/730,722, filed on Sep. 13, 2018.

(51) Int. Cl. H01M 2/26; H01M 10/04; H01M 2/02; H01M 4/70; H01M 4/66

(52) U.S. Cl. CPC H01M 2/263; H01M 10/0431; H01M 2/022; H01M 4/661; H01M 10/0422; H01M 4/70; H01M 10/0481

(57) ABSTRACT

An embodiment is directed to a cylindrical battery cell, comprising a cell can, a jelly roll area of anode electrode, separator, and cathode electrode foils arranged in a middle section of the cell can. The anode electrode foils, the cathode electrode foils, or both extend out of the jelly roll area into an electrolyte area of the cell can. In one embodiment, some of the extended electrode foils are in direct contact with an end (e.g., top or bottom) of the cell can. In another embodiment, the extended electrode foils contact a plurality of connection taps that are thermally and electrically connected to an end (e.g., top or bottom) of the cell can. In another embodiment, the extended electrode foils are bent and stacked so as to function as a foil-integrated connection tap that is thermally and electrically connected to an end (e.g., top or bottom) of the cell can.

### CROSS-REFERENCE TO RELATED APPLICATIONS

The present application for patent claims the benefit of U.S. Provisional Application No. 62/730,722 with attorney docket no. TIV-180006P1, entitled “INTERFACE BETWEEN JELLY ROLL AREA OF A BATTERY CELL AND BOTTOM OF CELL CAN”, filed Sep. 13, 2018, which is assigned to the assignee hereof and hereby expressly incorporated by reference herein in its entirety.

### BACKGROUND

### 1. Field of the Disclosure

Embodiments relate to an interface between a jelly roll area of a battery cell and a cell can of the battery cell.

### 2. Description of the Related Art

Energy storage systems may rely upon battery cells for storage of electrical power. During operation (e.g., charge-discharge cycles), battery cells generate heat which can contribute to thermal aging of the battery cells. A need exists to reduce the impact of thermal aging to battery cells so as to extend their cycle life.

### SUMMARY

An embodiment is directed to a cylindrical battery cell, comprising a cell can, a jelly roll area of anode electrode foils, separator foils, and cathode electrode foils arranged in a middle section of the cell can, wherein at least one of the electrode foils (e.g., the anode electrode foils, the cathode electrode foils, or both) extend out of the jelly roll area into an electrolyte area, a connection tap being thermally and electrically connected to a first end (e.g., top or bottom) the cell can, wherein a first subset of the at least one of the electrode foils is in direct contact with the first end of the cell can.

Another embodiment is directed to a cylindrical battery cell, comprising a cell can, a jelly roll area of anode electrode foils, separator foils and cathode electrode foils arranged in a middle section of the cell can, wherein at least one of the electrode foils (e.g., the anode electrode foils, the cathode electrode foils, or both) extend out of the jelly roll area into an electrolyte area, and a plurality of connection taps being thermally and electrically connected to a first end (e.g., top or bottom) of the cell can, wherein a first subset of the at least one of the electrode foils are in direct contact with a first of the plurality of connection taps, and wherein a second subset of the at least one of the electrode foils are in direct contact with a second of the plurality of connection taps.

Another embodiment is directed to a cylindrical battery cell, comprising a cell can, and a jelly roll area of anode electrode foils, separator foils and cathode electrode foils arranged in a middle section of the cell can, wherein at least one of the electrode foils (e.g., the anode electrode foils, the cathode electrode foils, or both) comprise parts that extend out of the jelly roll area into an electrolyte area, wherein the extended parts of the at least one of the electrode foils are bent and stacked so as to function as a foil-integrated connection tap that is thermally and electrically connected to a first end (e.g., top or bottom) of the cell can.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates an example of a battery module where a number of battery cells are arranged together.

FIG. 3A illustrates a conventional interface between a jelly roll area (e.g., comprising layered anode/cathode/separator foils) and a connection tap at the bottom of a battery cell.

FIG. 3B depicts arrows that are indicative of thermal flow (or heat movement) through the conventional interface of the battery cell shown in FIG. 3A.

FIG. 4A illustrates an interface between a jelly roll area (e.g., comprising layered anode/cathode/separator foils) and a cell can and connection tap at the bottom of a battery cell according to an embodiment of the disclosure.

FIG. 4B depicts arrows that are indicative of thermal conductivity or flow (or heat movement) through the interface of the battery cell shown in FIG. 4A.

FIG. 5 illustrates an interface between a jelly roll area (e.g., comprising layered anode/cathode/separator foils) and a plurality of connection taps at the bottom of a battery cell according to another embodiment of the disclosure.

FIG. 6 illustrates an interface between a jelly roll area (e.g., comprising layered anode/cathode/separator foils) and a foil-integrated connection tap at the bottom of a battery cell according to another embodiment of the disclosure.

FIGS. 7A-7D illustrates a process of forming a battery cell in accordance with an embodiment of the disclosure.

FIG. 8 illustrates a side-by-side comparison of thermal conductivity that is achievable using the conventional design of FIGS. 3A-3B contrasted with the designs depicted in any of FIGS. 4A, 5 and/or 6.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

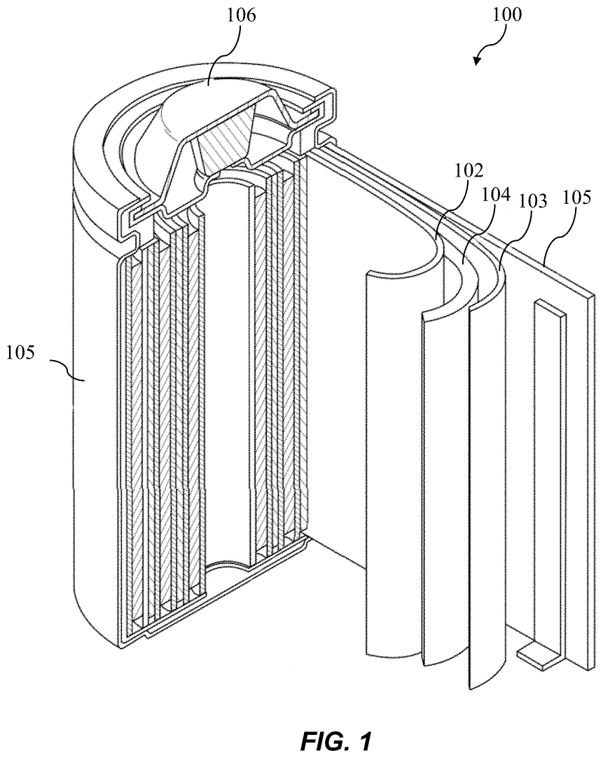

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

The layers of the battery cell 100 of FIG. 1 approximate a “jelly roll” configuration. In an example, the anode 102 may correspond to coated copper foil, the cathode 103 corresponds to coated aluminum foil, and the separator 104 may likewise be implemented via a separator foil. Hence, the jelly roll configuration of the battery cell 100 may correspond to a wound layer stack of coated copper foil—separator foil—coated aluminum foil—separator foil, etc. In some designs, while not shown expressly in FIG. 1, the coated copper foil can be connected to a tap that is welded to a bottom of the battery cell 100. This welding facilitates the bottom of the battery cell 100 to function as a negative terminal for the battery cell 100, i.e., by electrically connecting the jelly roll configuration to the cell can.

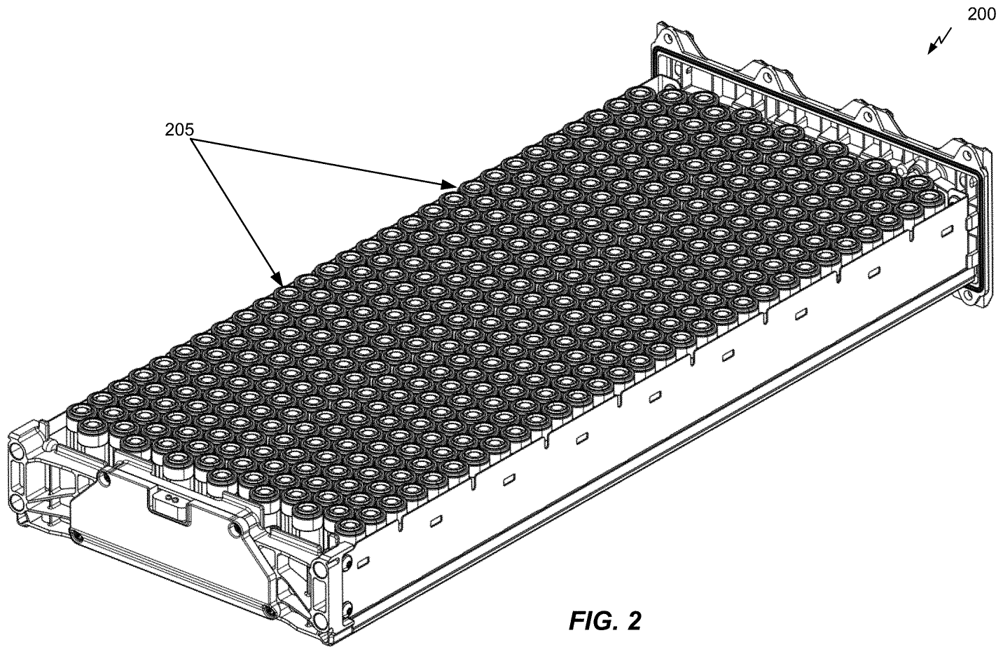

In certain implementations, cooling of battery cells such as the battery cell 100 of FIG. 1 is implemented at the cell bottom. For example, batteries such as the battery 100 depicted in FIG. 1 may be made part of a battery module. FIG. 2 illustrates an example of such a battery module 200, whereby a number of battery cells 205 are arranged together (e.g., into parallel groups of P-Groups of battery cells, with the P-Groups being connected in series to increase voltage). In such battery modules, a cooling plate (not shown) may be arranged underneath the battery module and thermally coupled (e.g., via a thermally conductive and electrically insulative coupling interface) to the bottoms of the battery cells 205. A cooling tube (not shown) may further be arranged underneath the cooling plate to transport heat away from the cell bottoms, whereby the cooling tube is configured to pump a liquid coolant provided from an external cooling system.

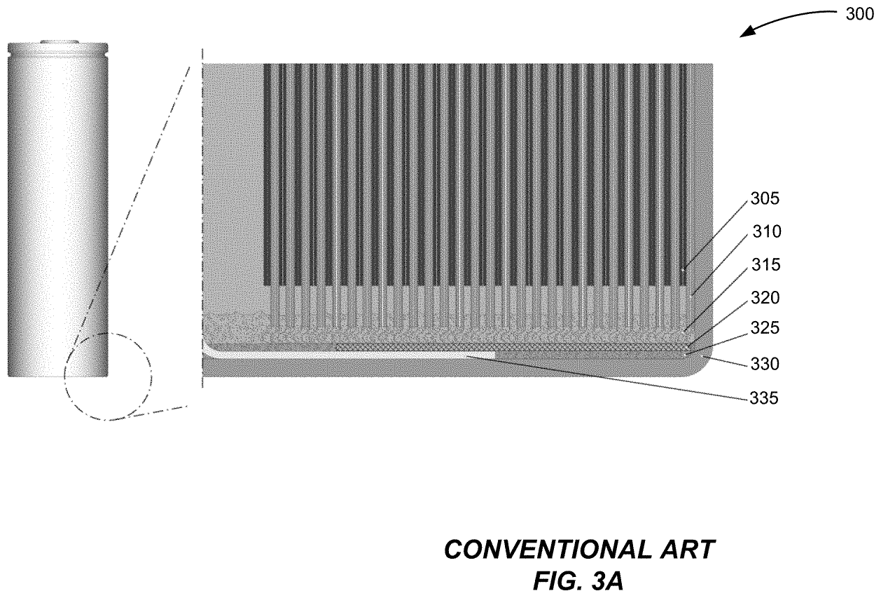

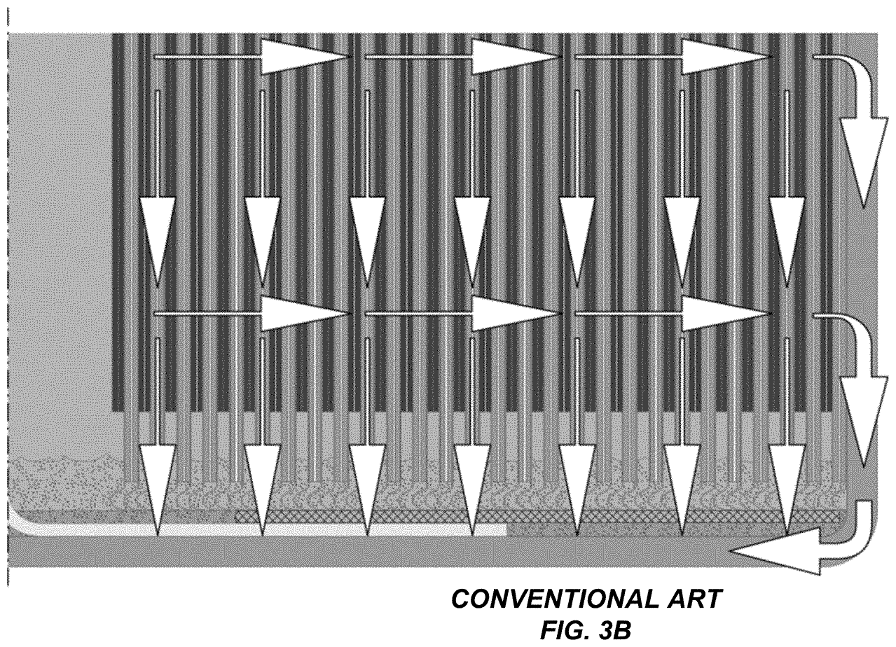

FIG. 3A illustrates a conventional interface 300 between a jelly roll area (e.g., comprising layered anode/cathode/separator foils) and a connection tap 335 at the bottom of a battery cell. Referring to FIG. 3A, the jelly roll area includes layers of coated aluminum foil 305 and coated copper foil 310 with separator foil 315 arranged in between. Separator foil 315 extends underneath the jelly roll area (e.g., depicted as wavy-black lines in electrolyte 325) and stop at an isolation disc 320. While not shown expressly in FIG. 3A, the coated copper foils 310 extend through the electrolyte 325 and are electrically connected to the connection tap 335. By contrast, the coated aluminum foil 305 (or cathode foil) may terminate in the jelly roll area. Moreover, the battery cell is encased in a cell can 330.

FIG. 3B depicts arrows that are indicative of thermal flow (or heat movement) through the conventional interface 300 of the battery cell shown in FIG. 3A. The arrows depicted in FIG. 3B are not drawn to scale, but thicker arrows are used to indicate greater thermal flow. As shown in FIG. 3B, heat generally moves across to the coated copper foils 310 and/or the cell can 330, and then downwards towards the bottom of the battery cell where the battery cell is thermally coupled to a cooling mechanism (such as a cooling plate).

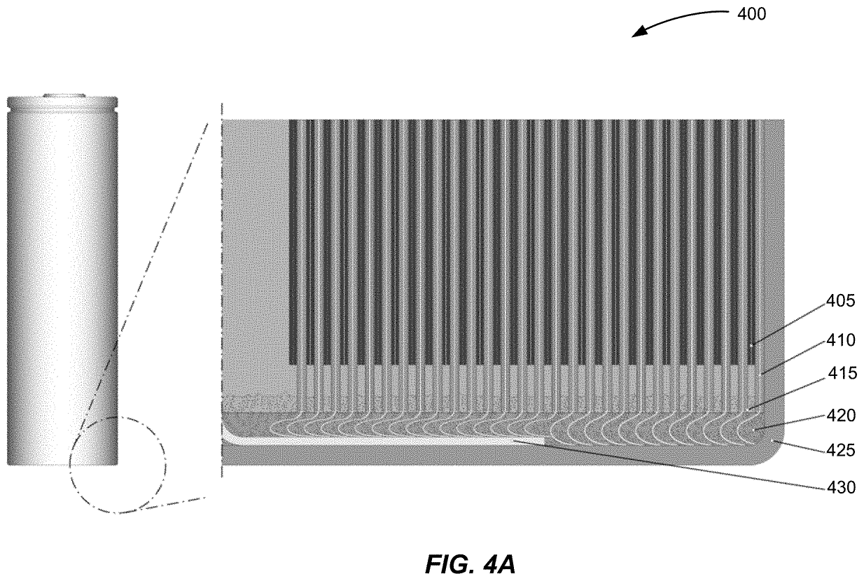

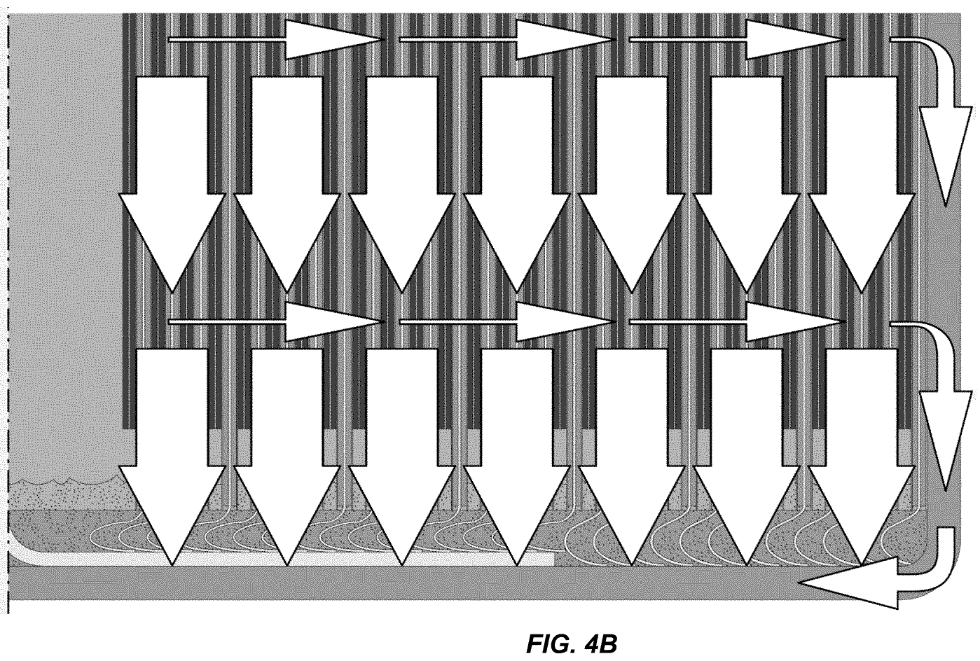

FIG. 4A illustrates an interface 400 between a jelly roll area (e.g., comprising layered anode/cathode/separator foils) and a cell can 425 and connection tap 430 at the bottom of a battery cell according to an embodiment of the disclosure. In an example, the connection tap 430 is welded to the cell can 425 during cell assembly. Referring to FIG. 4A, the jelly roll area includes layers of coated aluminum foil 405 and coated copper foil 410. Separator foil 415 is shortened relative to the separator foil 315, and does not extend underneath the jelly roll area down as far as where the isolation disc 320 is arranged in FIG. 3A, with the coated copper foils 410 extending further past the separator foil 415 and then through electrolyte 420. It is noted that in the perspective shown in FIG. 3A, the wavy black lines shown in the electrolyte 325 above the isolation disc 320 correspond to the separator foils 315, whereas in the perspective of FIG. 4A, the wavy white lines shown in the electrolyte 420 of FIG. 4A correspond to the coated copper foils 410.

The separator foil 415 is vertically shorter than the separator foil 315 of FIG. 3A, and the isolation disc 320 of FIG. 3A is removed entirely in the battery cell of FIG. 4A. In particular, the separator foil 415 (as well as the cathode foil 405) terminates inside the jelly roll area, in contrast to FIG. 3A where the separator foil 315 extends into the lower section and terminates at the isolation disc 320. For example, the coated aluminum foil 405 and coated copper foil 410 function as current collectors that are generally coated with an active material coating (e.g., graphene/graphite, Silicon, etc.) to facilitate electron transport during charge-discharge cycles of the battery. In other designs, the various foils of the layer stack may vary in length. In some designs, the dimensions at the ends (e.g., top and bottom) of the layer stack may be equal.

Moreover, a first subset of the coated copper foils 410 is in direct contact with and electrically connected to the connection tap 430, while a second subset of the coated copper foils 410 is in direct contact with and at least thermally connected to the cell can 425. In an example, the coated copper foils 410 may further be electrically connected to the cell can 425, either via direct connection or via an indirect connection through the connection tap 430. As shown in FIG. 4A, the coated copper foils 410 in the electrolyte 420 which are in direct contact with the cell can 430 may be curved so as to be arranged as a type of spring (i.e., ‘spring-loaded’), whereby the spring tension may help to cause the coated copper foils 410 to remain pressed against (e.g., thermally and/or electrically coupled with) the cell can 430 over time. In a further example, the coated copper foils 410 in direct contact with the connection tap 430 may likewise be spring-loaded so as to apply spring tension to the connection tap 430. In an example, the electrolyte 420 may provide additional thermal conductivity by wetting the associated parts.

FIG. 4B depicts arrows that are indicative of thermal conductivity or flow (or heat movement) through the interface 400 of the battery cell shown in FIG. 4A. The arrows depicted in FIG. 4B are not drawn to scale, but thicker arrows are used to indicate greater thermal flow. Hence, as evidenced by the thicknesses of the arrows in FIG. 4B relative to the arrows in FIG. 3B, the thermal conductivity of the battery cell is increased across the interface 400 of FIG. 4A relative to the interface 300 of FIG. 3A. As shown in FIG. 4B, heat generally moves across to the coated copper foils 410 and/or the cell can 430, and then downwards towards the bottom of the battery cell where the battery cell is thermally coupled to a cooling mechanism (such as a cooling plate). By thermally coupling some or all of the coated copper foils 410 to the bottom of the cell can 430, the thermal conductivity of the interface 400 is increased, which decreases the thermal ‘aging’ of the battery cell during cycling (e.g., extending the battery life of the battery cell). Moreover, in the scenario where the coated copper foils 410 are both thermally and electrically coupled to the bottom of the cell can 430, the electrical resistance of the battery cell is decreased (e.g., reducing power loss and heat production during cell operation).

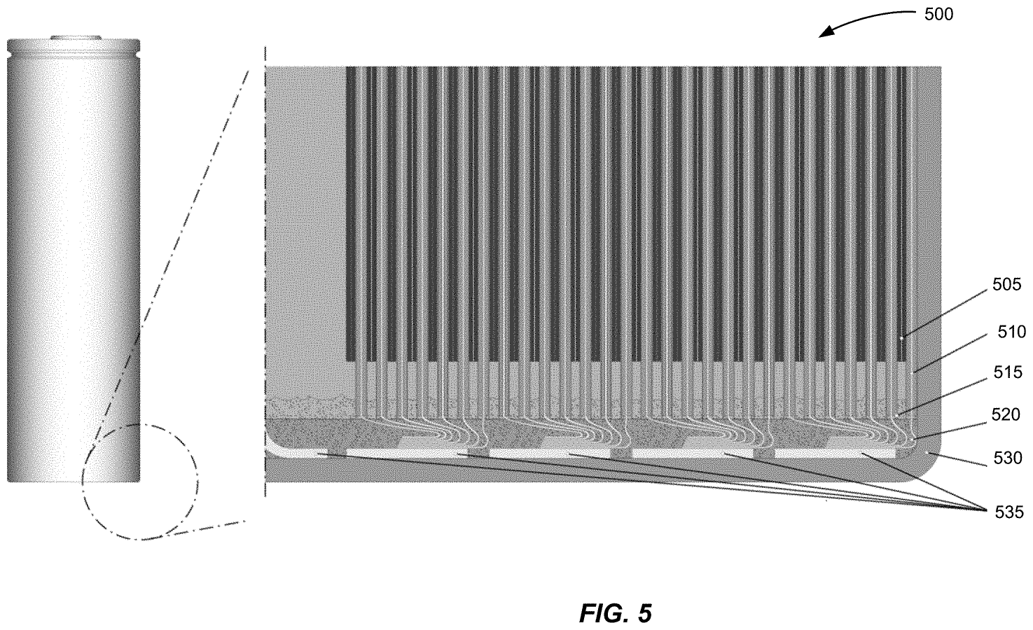

FIG. 5 illustrates an interface 500 between a jelly roll area (e.g., comprising layered anode/cathode/separator foils) and a plurality of connection taps 535 at the bottom of a battery cell according to another embodiment of the disclosure. Referring to FIG. 5, the jelly roll area includes layers of coated aluminum foil 505 and coated copper foil 510. Separator foil 515 is shortened relative to the separator foil 315, and does not extend underneath the jelly roll area down as far as where the isolation disc 320 is arranged in FIG. 3A, with the coated copper foils 510 extending further past the separator foil 515 and then through electrolyte 520. In particular, the separator foil 515 (as well as the cathode foil 505) terminates inside the jelly roll area, in contrast to FIG. 3A where the separator foil 315 extends into the lower section and terminates at the isolation disc 320. In other designs, the various foils of the layer stack may vary in length. In some designs, the dimensions at the ends (e.g., top and bottom) of the layer stack may be equal. It is noted that in the perspective shown in FIG. 3A, the wavy black lines shown in the electrolyte 325 above the isolation disc 320 correspond to the separator foils 315, whereas in the perspective of FIG. 5, the wavy white lines shown in the electrolyte 520 correspond to the coated copper foils 510.

Similar to FIG. 4A, the separator foil 515 of FIG. 5 is vertically shorter than the separator foil 315 of FIG. 3A, and the isolation disc 320 of FIG. 3A is removed entirely in the battery cell of FIG. 5. In the interface 500 of FIG. 5, the coated copper foils 510 are thermally and electrically coupled to multiple connection taps 535, which are in turn both thermally and electrically coupled to a cell can 530. As shown in FIG. 5, the coated copper foils 510 in the electrolyte 520 may be curved so as to be arranged as a type of spring (i.e., ‘spring-loaded’), whereby the spring tension may help to cause the coated copper foils 510 to remain pressed against (e.g., thermally and electrically coupled with) the multiple connection taps 535 over time. In an example, the electrolyte 520 may provide additional thermal conductivity by wetting the associated parts. While not shown illustratively, the thermal conductivity characteristics of the battery cell of FIG. 5 may be similar to the thermal conductivity or flow depicted via arrows with respect to FIG. 4B. In other designs, the various foils of the layer stack may vary in length. In some designs, the dimensions at the ends (e.g., top and bottom) of the layer stack may be equal.

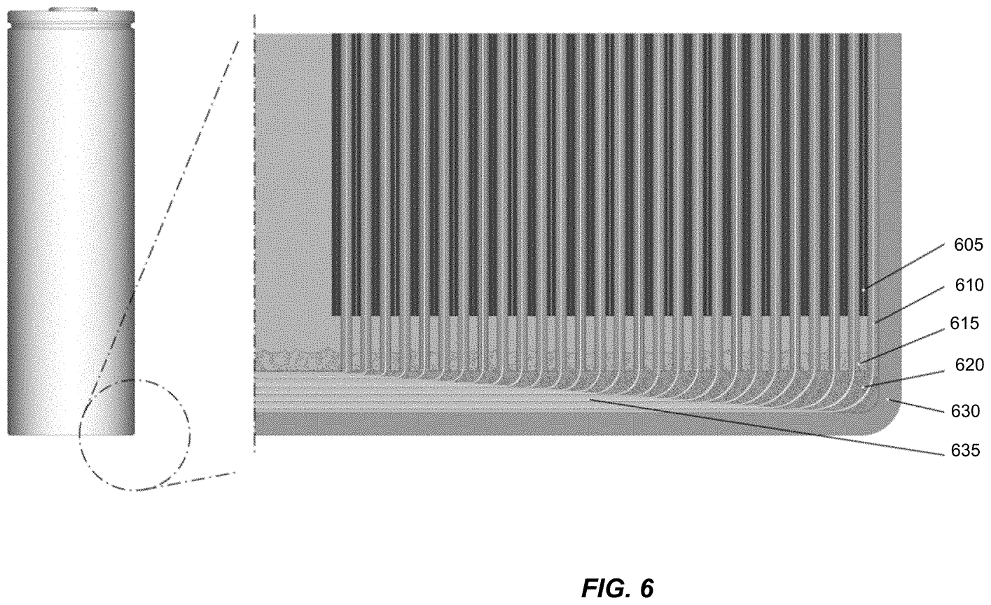

FIG. 6 illustrates an interface 600 between a jelly roll area (e.g., comprising layered anode/cathode/separator foils) and a foil-integrated connection tap 635 at the bottom of a battery cell according to another embodiment of the disclosure. Referring to FIG. 6, the jelly roll area includes layers of coated aluminum foil 605 and coated copper foil 610. Separator foil 615 is shortened relative to the separator foil 315, and does not extend underneath the jelly roll area down as far as where the isolation disc 320 is arranged in FIG. 3A, with the coated copper foils 610 extending further past the separator foil 615 and then through electrolyte 620. In other words, the separator foil 615 (as well as the cathode foil 605) terminates inside the jelly roll area, in contrast to FIG. 3A where the separator foil 315 extends into the lower section and terminates at the isolation disc 320. In other designs, the various foils of the layer stack may vary in length. In some designs, the dimensions at the ends (e.g., top and bottom) of the layer stack may be equal. It is noted that in the perspective shown in FIG. 3A, the wavy black lines shown in the electrolyte 325 above the isolation disc 320 correspond to the separator foils 315, whereas in the perspective of FIG. 6, the wavy white lines shown in the electrolyte 620 correspond to the coated copper foils 610.

Similar to FIG. 4A and FIG. 5, the separator foil 615 of FIG. 6 is vertically shorter than the separator foil 315 of FIG. 3A, and the isolation disc 320 of FIG. 3A is removed entirely in the battery cell of FIG. 6. In other designs, the various foils of the layer stack may vary in length. In some designs, the dimensions at the ends (e.g., top and bottom) of the layer stack may be equal. In the interface 600 of FIG. 6, the coated copper foils 610 are integrated into the connection tap 635. More specifically, the foil-integrated connection tap 635 is configured as multiple layers of the stacked copper foils 610. The foil-integrated connection tap 635 is both thermally and electrically coupled to a cell can 630. In an example, the electrolyte 620 may provide additional thermal conductivity by wetting the associated parts. While not shown illustratively, the thermal conductivity characteristics of the battery cell of FIG. 6 may be similar to the thermal conductivity or flow depicted via arrows with respect to FIG. 4B.

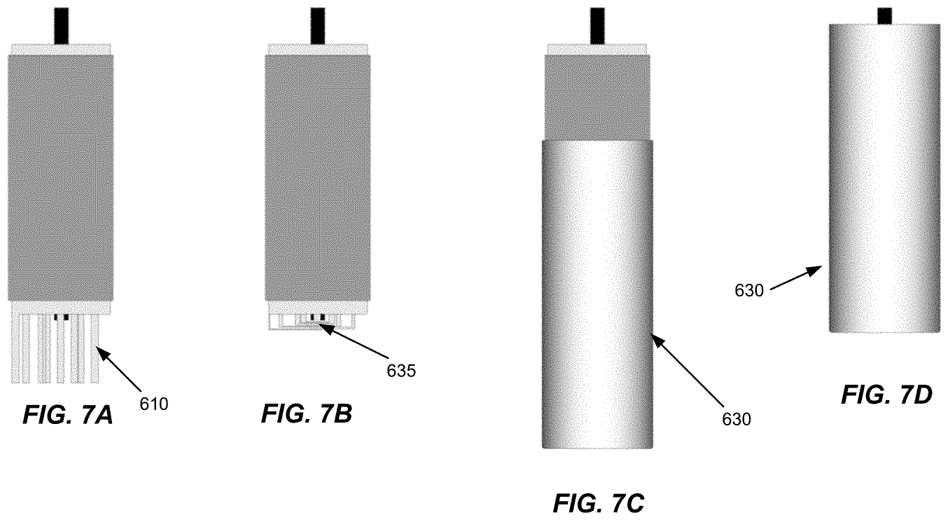

FIGS. 7A-7D illustrates a process of forming a battery cell in accordance with an embodiment of the disclosure. In particular, the process of FIGS. 7A-7D shows an example of how to form a battery cell including the interface 600 with the foil-integrated connection tap 635 depicted in FIG. 6.

At FIG. 7A, the jelly roll configuration of the battery cell is wound. As shown in FIG. 7A, the coated copper foils 610 extend down past the jelly roll area (e.g., in contrast to coated aluminum foils and separator foils that are constrained to the jelly roll area). At FIG. 7B, the foil-integrated connection tap 635 is formed (e.g., by bending the ends of the coated copper foils 610). At FIG. 7C, the jelly roll configuration (with the foil-integrated connection tap 635) is joined with the cell can 630. At FIG. 7D, the foil-integrated connection tap 635 (not shown) is welded to the cell can 630.

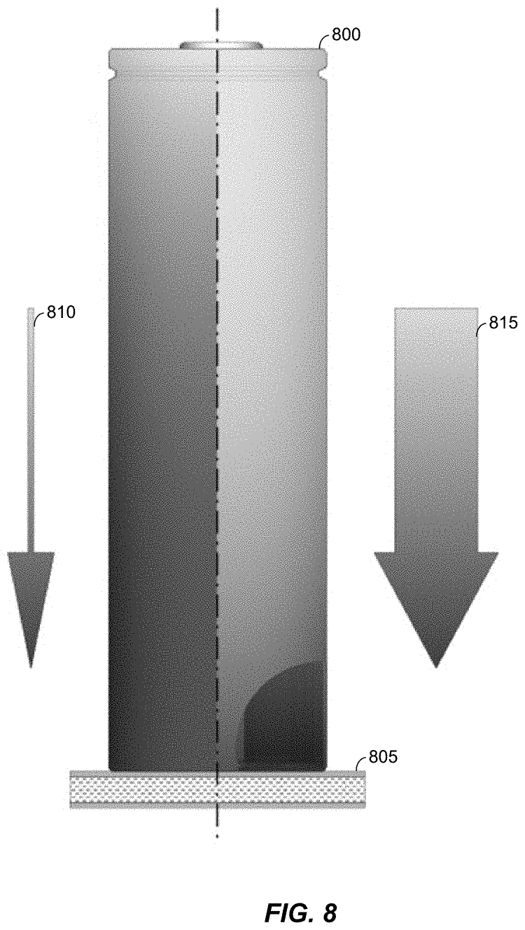

FIG. 8 illustrates a side-by-side comparison of thermal conductivity that is achievable using the conventional design of FIG. 3A contrasted with the designs depicted in any of FIGS. 4A, 5 and/or 6. In FIG. 8, a battery cell 800 is arranged with a cooling plate 805. More specifically, the cooling plate 805 is arranged underneath the battery cell 800 at the cell bottom. While not drawn to scale, the arrows 810 and 815 are intended to visually depict degrees to which thermal flow (e.g., from inside of the jelly roll configuration to the bottom of the cell) can be achieved for the battery cell 800 in accordance with certain conventional designs (810—FIG. 3A) contrasted with certain embodiments of the present disclosure (815—any of FIG. 4A, 5 or 6). The thicknesses of the arrows 810-815 is not drawn to scale, but is intended to be generally indicative of the degree of thermal conductivity in the battery cell 800.

While the embodiments are described above in context with an interface between anode foils and a bottom of a cell can, other embodiments are directed to a similar interface between cathode foils and a top of the cell can. Hence, while illustrated in an anode-specific context, FIGS. 4A-8 are also representative of a cathode implementation that may be adopted at the top of the cell can. In some designs, anode foils may extend out of the jelly roll area into a first electrolyte area so as to interface with a bottom of the cell can while cathode foils may similarly extend out of the jelly roll area into a second electrolyte area so as to interface with a top of the cell can (e.g., in an arrangement as described above with respect to any of FIGS. 4A-8 except for being mapped to the top of the cell can instead of the bottom of the cell can). The jelly roll area may thereby be characterized as being positioned in a “middle” area (or section) that is arranged between the top and bottom of the cell can.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A cylindrical battery cell, comprising:
a cell can;
a jelly roll area of anode electrode foils, separator foils, and cathode electrode foils arranged in a middle section of the cell can, wherein at least one of the electrode foils extend out of the jelly roll area into an electrolyte area; and
a connection tap being thermally and electrically connected to a first end the cell can,
wherein a first subset of the at least one of the electrode foils is in direct contact with the first end of the cell can.

2. The cylindrical battery cell of claim 1,
wherein the at least one of the electrode foils comprises the anode foils,
wherein the anode foils extend out of the jelly roll area into a lower section of the cell can,
wherein the connection tap is arranged in the lower section, and
wherein the first end of the cell can corresponds to a bottom of the cell can.

3. The cylindrical battery cell of claim 2, wherein, for each anode foil among the first subset of anode foils, a respective part of the anode foil in the lower section of the cell can is spring-loaded so as to apply spring tension to the cell can.

4. The cylindrical battery cell of claim 2, wherein a second subset of the anode foils is in direct contact with the connection tap.

5. The cylindrical battery cell of claim 4, wherein, for each anode foil among the second subset of anode foils, a respective part of the anode foil in the lower section of the cell can is spring-loaded so as to apply spring tension to the connection tap.

6. The cylindrical battery cell of claim 2,
wherein the anode foils comprise copper, and
wherein the cathode foils comprise aluminum.

7. The cylindrical battery cell of claim 2, wherein the first subset of the anode foils is at least thermally coupled to the bottom of the cell can.

8. The cylindrical battery cell of claim 7, wherein the first subset of the anode foils is both thermally and electrically coupled to the bottom of the cell can.

9. The cylindrical battery cell of claim 1,
wherein the at least one of the electrode foils comprises the cathode foils,
wherein the cathode foils extend out of the jelly roll area into a top section of the cell can,
wherein the connection tap is arranged in the top section, and
wherein the first end of the cell can corresponds to a top of the cell can.

10. A cylindrical battery cell, comprising:
a cell can;
a jelly roll area of anode electrode foils, separator foils and cathode electrode foils arranged in a middle section of the cell can, wherein at least one of the electrode foils extend out of the jelly roll area into an electrolyte area; and
a plurality of connection taps being thermally and electrically connected to a first end of the cell can,
wherein a first subset of the at least one of the electrode foils are in direct contact with a first of the plurality of connection taps, and
wherein a second subset of the at least one of the electrode foils are in direct contact with a second of the plurality of connection taps.

11. The cylindrical battery cell of claim 10,
wherein the at least one of the electrode foils comprises the anode foils,
wherein the anode foils extend out of the jelly roll area into a lower section of the cell can,
wherein the plurality of connection taps are arranged in the lower section, and
wherein the first end of the cell can corresponds to a bottom of the cell can.

12. The cylindrical battery cell of claim 11, wherein, for each anode foil among the first and second subsets of anode foils, a respective part of the anode foil in the lower section of the cell can is spring-loaded so as to apply spring tension to a respective connection tap.

13. The cylindrical battery cell of claim 11,
wherein the anode foils comprise copper, and
wherein the cathode foils comprise aluminum.

14. The cylindrical battery cell of claim 11,
wherein the at least one of the electrode foils comprises the cathode foils,
wherein the cathode foils extend out of the jelly roll area into a top section of the cell can,
wherein the plurality of connection taps are arranged in the top section, and
wherein the first end of the cell can corresponds to a top of the cell can.

15. A cylindrical battery cell, comprising:
a cell can; and
a jelly roll area of anode electrode foils, separator foils and cathode electrode foils arranged in a middle section of the cell can, wherein at least one of the electrode foils comprise parts that extend out of the jelly roll area into an electrolyte area,
wherein the extended parts of the at least one of the electrode foils are bent and stacked so as to function as a foil-integrated connection tap that is thermally and electrically connected to a first end of the cell can.

16. The cylindrical battery cell of claim 15,
wherein the at least one of the electrode foils comprises the anode foils,
wherein the anode foils extend out of the jelly roll area into a lower section of the cell can, and
wherein the first end of the cell can corresponds to a bottom of the cell can.

17. The cylindrical battery cell of claim 16,
wherein the anode foils comprise copper, and
wherein the cathode foils comprise aluminum.

18. The cylindrical battery cell of claim 15,
wherein the at least one of the electrode foils comprises the cathode foils,
wherein the cathode foils extend out of the jelly roll area into a top section of the cell can, and
wherein the first end of the cell can corresponds to a top of the cell can.
